(19) United States
(12) Patent Application Publication
(10) Pub. No.: US 2003/0152685 A1
(43) Pub. Date: Aug. 14, 2003

(54) Frozen dairy product

(76) Inventor: Robert S. Baker, Long Grove, IL (US)

Correspondence Address: Leon I. Edelson, Levenfeld Pearlstein, PO Box 0212, Chicago, IL, 60690-0212, US

(21) Appl. No.: 10/386,341

(22) Filed: Mar. 11, 2003

Related U.S. Application Data
(63) Continuation-in-part of application No. 09/572,741, filed on May 17, 2000, now Pat. No. 6,551,646.

(51) Int. Cl. A23G 9/00

(52) U.S. Cl. 426/565

(57) ABSTRACT

A soft frozen fruit flavored dairy milk product is disclosed of water, sucrose sugar sweetener, fruit juice and dairy milk of 3 to 5 weight percent dairy milk fat with coalesced fat globules present to enhance the sucrose sugar sweetener, free of added emulsifiers, stabilizers, artificial coloring and without introduction of air in the mix, wherein two separate freezing steps develop a mouthfeel with components of the fruit flavor and coalesced fat globules.

### CROSS REFERENCE TO RELATED APPLICATIONS

Continuation-in-part of Serial No. 09/572,741, May 17, 2000.

### FIELD OF THE INVENTION

This invention relates to a unique soft frozen fruit flavored dairy product and the process of production.

### BACKGROUND OF THE INVENTION

Frozen dairy products such as ice cream are typically prepared in a process whereby the ingredients are added to a storage container, blended with mixing, homogenized by means of a homogenizer, cooled within the range of 32° F. to about 40° F., then sent to storage until flavor ingredients can be added. The mix is then frozen at about 21° F., packaged at 21° F., wrapped and finally hardened at a temperature from about −45° F. to −50° F. The frozen dairy product quality accordingly is determined by the ingredients and details of the process used to prepare the frozen product.

Frozen dairy products such as ices and sherbets have been prepared in the same procedure as above with modifications of the process. The mix is prepared by adding the ingredients to water with heating to obtain a solution, which is then cooled. Homogenization is not usually useful. Fruit juices, flavoring, coloring, and acid solutions of fruit acids comprise the flavor and color mixture. The formula for sherbets can comprise an ice cream mix containing milk fat to supply a milk fat content to the sherbet of up to about 3 wt % Rapid agitation of the mix causes air to be incorporated into the product and increases the volume of the product. The mixture is then frozen.

Accordingly, the preparation of conventional frozen dairy products consists of a process wherein the ingredients are added to a storage container, blended with mixing, then mixed with flavoring materials with incorporation of air, frozen at a suitable temperature, packaged and wrapped. Hardening of the product can take place at a low temperature.

The popularity of soft frozen ice cream and drinks has led to a desire to produce a soft frozen fruit flavored dairy product with natural fruit flavors. This desire has not been attained, to date, because a soft frozen fruit flavored dairy product has not been acceptable to consumers without the addition of emulsifiers, stabilizers and artificial coloring. When these are added to a base soft frozen dairy product, the flavor of the end product can be tainted or lessened in fullness by the presence of the emulsifier's stabilizers and artificial coloring. The product can have an artificial or off-flavor, not like that of the natural fruit flavor.

A further problem is that if a fruit flavor such as a fruit juice containing a significant amount of water is frozen over a period of time ice crystals develop. Mouth feel is affected by size of ice crystals within the frozen composition. Larger ice crystals import a grainy mouth feel. Smaller ice crystal results in a smoother frozen composition mouthfeel.

Considerable effort has been expended to develop a soft frozen comestible, which can serve as a frozen dessert. U.S. Pat. No. 3,922,361 to Vann, U.S. Pat. No. 4,500,553 to Ligget, U.S. Pat. No. 4,724,153 to Dulin, U.S. Pat. No. 4,737,374 to Huber, and U.S. Pat. No. 5,084,295 to Whelan disclose frozen food products which are soft-serve products. There is considerable other published art on the subject of frozen desserts. A pertinent text is Ice cream, Fifth Edition, by R. T. Marshall and W. S. Arbuckle, published by International Thomson Publishing, N.Y., N.Y.

### BRIEF SUMMARY OF THE INVENTION

A soft frozen fruit flavored dairy milk product is disclosed of water, sucrose sugar sweetener, fruit juice and dairy milk of 3 to 5 weight percent dairy milk fat with coalesced fat globules present to enhance the sucrose sugar sweetener, free of added emulsifiers, stabilizers, artificial coloring and without introduction of air in the mix, wherein two separate freezing steps develop a mouthfeel with components of the fruit flavor and coalesced fat globules.

### BRIEF DESCRIPTION OF THE DRAWINGS

Not applicable.

### DETAILED DESCRIPTION

A process has been devised for producing a unique soft frozen fruit flavored dairy product. In its broadest form, the process comprises forming a soft frozen fruit flavored intermediate concentrate of the desired consistency based on water, a sweetener, and designated fruit juices and mixing the intermediate concentrate with dairy milk fat to form a soft frozen fruit flavored dairy product.

The product prepared by the process of the instant invention is by a process requiring two freezing steps, without introduction of air, wherein the flavoring materials are initially frozen before dairy milk fat is added to the mix. The flavoring material together with the contained dairy milk fat is then frozen again to result in a product with hydration within the range of from about 70% to 80%, preferably of about 75% and a viscosity of about 1800 cps. The first freezing step is at a temperature of less than about −3° F. The second freezing step is at a temperature of less than about −3° F.

When a person eats a frozen product, the taste buds are partially anesthetized and a sweet fruit flavor tastes more tart. In the adjustment of this taste, the presence of a sweetener such as sucrose affects the viscosity of the solution and the mouth feel of the frozen composition. The addition of an acidic fruit juice, such as lemon juice containing a citric acid component, to the frozen product attenuates the excessive sweet taste due to the presence of a sweetener and aids in the creation of a unique taste sensation. Aging of the frozen composition in a warming process reduces ice crystal size and aids in development of a mouthfeel.

Dairy milk with a milk fat content of about 3 to 5% weight content is added to a warmed ice solution of a frozen fruit water solution of sucrose. Fat globules from the dairy milk fat cause the solution to coalesce to form a structure of coalesced fat globules in the presence of mixing. The resulting product, on re-freezing of the semi-frozen fruit-water solution of sucrose and milk fat to a soft frozen stage, develops a mouthfeel with components of the sweet fruit flavor, the sucrose sweetener being enhanced by the presence of the coalesced fat globules.

The solution of water, sweetener, and fruit juices is slush frozen at a temperature of less than about −3° F. for a designated period without stirring to permit ice crystals to form of the solution components to obtain a mixture of ice crystals, water, solubilized sucrose and fruit juice components disposed in a continuous liquid phase as a water ice mix without any dairy products present. The water ice mix is then aged for a sufficient period at a warming temperature to prepare a more slushy water ice mix without stirring or mixing, thus producing a more slushy water ice. Pasteurized dairy milk with a milk fat content of about 3 wt. % to 5 wt. % is added to the slush thawed water ice mix with moderate mixing, without forced introduction of air.

It is essential that the soft frozen fruit flavored dairy product be prepared without forced introduction of air in the mixing and freezing steps to control the quality of the product. The water ice-mix-milk solution is frozen at a temperature of less than about −3° F. for period of time sufficient to permit hydration of the proteins present in the solution. The frozen water ice-milk solution is then packaged into a convenient size. At the point of use, the soft frozen fruit flavored dairy product can be eaten with a spoon as a frozen solid or allowed to melt to a slush frozen consistency and sipped as a drink.

Cow's milk fat is composed of about 140 different fatty acids and glycerol connected through ester linkages. The dairy milk is necessarily pasteurized to minimize development of off-flavors. The water-ice mix-milk solution is necessarily protected from copper or iron as these metals dissolve in cow's milk and catalyze oxidation of frozen milk.

The base concentrate of water, sweetener (sucrose), fruit-juice that is used (for a pineapple juice product, as an example) should preferably have the following chracteristics:

1. Brix −61.0° to 75.0° of the sugar (sucrose) water solution. Brix is defined on an arbitrary hydrometer scale for expressing the specific gravity of liquids, especially sugar solutions, according to the formula: specific gravity=400/4000+n) at 15.6° C. wherein n represents the reading on the scale. The Brix reading represents percentages by weight of the sugar in the solution of water and sugar;

2. Sugar/fruit juice weight ratio −0.65:1 to 0.74:1, preferably 0.69:1 to 70:1;

3. No floating pulp in the fruit juice;

4. Bottom and suspended pulp in the fruit juice: 9%-11%;

5. No separation of the fruit juice; and

6. Brix of the fruit juices utilized −10.0° to 15.0°.

The characteristic of the dairy milk added to the base concentrate should be as follows: total fat −3.00 to 5.00 wt %, preferably about 5.00 wt %.

To more clearly define the product and procedure for this invention, the following description is provided.

The product prepared by the process for the instant invention is by a process requiring two freezing steps without introduction of air concurrent with aging periods wherein the base concentrate containing the water, sweetener, and fruit flavoring is frozen to a soft freeze of a slush consistency. The freezing procedure is performed without mixing or stirring and without introduction of air to allow ice crystals to form, preferably of small size and not equal in size. After a designated aging period wherein the base concentrate is exposed to a freezing temperature, the slush frozen base concentrate solution is removed from the freezing chamber and tempered in a warming chamber to cause the small ice crystals to melt but allowing the larger ice crystals to remain as components, thus increasing the slush consistency of the base concentrate solution. The heat treatment facilitates hydration of the base concentrate solution mix particles. Dairy milk with an increased fat content, greater than that of raw milk, is thereupon added to the base concentrate solution with slow mixing to avoid introduction of air into the mix. The base concentrate solution and milk composite solution is frozen and aged to develop mix stability and hydration of the mix particles.

In summary, the instant invention comprises a soft frozen dairy product by a process which comprises the steps of:

a) Mixing a volume of water of fluid ounces with an equal weight of sucrose sweetener in ounces avoirdupois at a suitable temperature to form a sugar-water solution wherein Brix reading as to percentage of sugar in said sugar-water solution is approximately 61°% to 75°% as measured upon a Brix scale;

b) Adding a fluid volume of a first fruit juice to said sugar-water solution wherein fluid volume of said first fruit juice in fluid ounces is at least twice the fluid volume of said water of said sugar-water solution;

c) Mixing said sugar-water solution and said first fruit juice to form a first mixture without introduction of air into said first mixture;

d) Adding a second fruit juice to said first mixture in an amount lesser than the amount of the first fruit juice and mixing said second fruit juice into said first mixture to form a second mixture without introduction of air into said second mixture;

e) Freezing said second mixture without introduction of air at a temperature of less than −3° F. in a first freezing step in a freezing chamber for a period of time sufficient to cause ice crystals to form and to harden said second mixture;

f) Warming said hardened second mixture in a warming chamber for a period of time sufficient to melt ice crystals formed in said freezing chamber wherein said hardened second mixture is partly melted to slush consistency;

g) Adding a fluid volume of dairy milk of prescribed fat content to said partly melted second mixture to form a third mixture wherein fluid volume of said milk is approximately one-half of liquid volume of said water in said sugar-water solution;

h) Mixing said third mixture without introduction of air into said third mixture;

i) Freezing said third mixture without introduction of air in a second freezing step in a freezing chamber at a temperature of at least −3° F. for a period of time sufficent to cause the frozen dairy product to have a soft-frozen consistency.

Specific details of the process steps are as follows:

1. Specific gravity of the sucrose sugar-water solution is 1.195 to 1.210, preferably about 1.205;

2. Temperature of water added to form the sugar-water solution: approximately 180° F. or more, preferably boiling at atmospheric pressure;

3. Temperature of the fruit juices added: 40° F. as to a minimum, preferably 55° F. to 65° F.;

4. Fruit juices added: major component selected from pineapple juice, orange juice, apple juice, a second fruit juice such as a citrus fruit juice as lemon juice;

5. Specific gravity of example of pineapple juice approximately: 1.015; Specific gravity of example of lemon juice approximately: 1.036;

6. Temperature of example of sugar, water, pineapple juice and lemon juice solution: within range of 65° F. to 80° F., preferably 72° F. to 75° F.;

7. Mixing time of example of sugar, water, pineapple juice and lemon juice solution: 30 seconds concurrent with temperature rise to about 77° F.; the mixer is a blender; or the mix is stirred by hand.

8. Freezing temperature first freeze: within range of −10° F. to −2° F., preferably about −3° F. for four hours;

9. Hydration of mix particles after first freeze: within range of about 70.0% to about 80%, preferably about 76%;

10. Warming chamber temperatures after first freeze period: within range of 70° F. to 80° F., preferably about 76° F., time about 2 hours;

11. Addition of dairy milk with 3 to 5 weight percentage milk fat with mixing but without introduction of air;

12. Freezing temperature for second freeze: preferably about −3° F. for at least four hours to allow large ice crystals to form;

13. Hydration of mix particles after second freeze within range of about 70% to 80%, preferably about 75%, viscosity of product approximately 1800 c.p.s.;

14. Package in a suitable container at a temperature lower than −3° F.

In more specific detail, the soft frozen dairy product is prepared by:

a. Mixing a volume of water of fluid ounces with an equal weight of cane sugar (sucrose) sweetener in ounces avoirdupois at a suitable temperature to form a sugar-water solution wherein Brix reading at to percentage of sugar in said sugar-water solution is measured as approximately 61° Brix to 75° as measured upon a Brix scale;

b. Adding a fluid volume of a first fruit juice to said sugar-water solution wherein fluid volume of said first fruit juice in fluid ounces is at least twice the fluid volume of said water of said sugar-water solution;

c. Mixing said sugar-water solution and said first fruit juice to form a first mixture without introduction of air into said first mixture;

d. Adding a second fruit juice to said first mixture in an amount lesser than the amount of the first fruit juice and mixing said second fruit juice into said first mixture to form a second mixture as a base concentrate solution without introduction of air into said second mixture;

e. Freezing without introduction of air said second mixture at a temperature of less than −3° F. in a first freezing step in a freezing compartment for a period of time sufficient to cause ice crystals to form and to harden said second mixture;

f. Warming said hardened second mixture in a warming chamber for a period of time sufficeint to melt small ice crystals formed in said freezing chamber wherein said hardened second mixture is partly melted to slush consistency;

g. Adding a fluid volume of dairy milk of prescribed milk fat content to said partly melted second mixture to form a third mixture as a milk composite solution wherein fluid volume of said milk is approximately one-half of liquid volume of said water in said sugar-water solution;

h. Mixing said third mixture without introduction of air into said third mixture to cause the solution to form a structure of coalesced fat globules in the presence of mixing; and

i. Freezing and aging said third mixture of base concentrate solution and milk as a composite solution in a second freezing step in a freezing chamber at a temperature of at least −3° F. for a period of time sufficient to cause the frozen dairy product to develop mix stability and hydration of the mix particles and have a soft-frozen consistency.

The said first fruit juice is selected from the group consisting of pineapple juice, apple juice, orange juice, and the second fruit juice can be lemon juice. Alternatively, the second fruit juice can be juice of a citrus fruit other than lemon.

In detail, specifics of following example for the preparation of the soft frozen dairy product are: fluid volume of water is approximately 16 ounces, weight of said sucrose sweetener is approximately 16 ounces avoirdupois, fluid volume of said first fruit juice is approximately 32 fluid ounces, fluid volume of said second fruit juice is approximately 3 fluid ounces, freezing of said second mixture in a first freezing step at a temperature of less than about −3° F. is for a period of from four to five hours, warming of said hardened second mixture is over a period of from one to two hours at a temperature within the range of from about 70° F. about 80° F., fluid volume of dairy milk added to said second mixture to form said third mixture is apprxoimately 8 fluid ounces, freezing of said third mixture in a second freezing step at a temperature of less than about −3° F. for a period of at least three hours, the process steps consisting of a) forming a soft frozen base concentrate of water, a sweetener, and fruit juice, thawing said concentrate to substantially slush consistency, b) adding dairy milk of a predetermined milk fat content over that of raw milk within the range of from about 3 wt % fat to 5 wt % fat content, c) subsequently freezing said soft frozen base concentrate with added dairy milk of said milk fat content to a slush frozen product wherein said soft frozen base concentrate and the said soft frozen base concentrate with added dairy milk have the following characteristics:

a) Soft frozen base concentrate of water, sweetener and fruit juices:

1) Brix=61.0° to 75.0°

2) Sugar/fruit weight ratio=0.65:1 to 0.74:1;

3) Particle hydration: 70.0% to 80.0%

b) Soft frozen base concentrate with dairy milk

1) Brix=61.0° to 75.0°

2) Particle hydration: 70.0% to 80%

3) Viscosity: about 1800 c.p.s.

The following summary example illustrates the product of the instant invention and process to produce the product.

### EXAMPLE

Sixteen fluid ounces of water are added to sixteen ounces by weight of cane sugar (sucrose) at a water temperature of over 180° F., suitably at a boiling temperature, in a suitable container and mixed until the sugar is dissolved to prepare a sugar-water solution wherein Brix is approximately 68°. In the next step, fruit juice, thirty-two fluid ounces is poured into the sugar-water solution, and mixed without introduction of air. A second addition of a fruit juice, in an amount of about three fluid ounces is then added, with mixing, without the addition of air. The resulting base concentrate is then frozen in a freezing chamber wherein the temperature is at least −3° F. for a period of from four to five hours to allow ice crystals to form and grow. The frozen base concentrate is removed from the freezing chamber and placed in a warming chamber to allow the smaller ice crystals formed in the freezing step to melt but allow the larger ice crystals to remain to obtain a slush consistency. The warming chamber is at a temperature of from 70° F. to about 80° F. The warming period is from one to two hours to allow the base concentrate solution to develop a slush consistency of large ice crystals. Eight fluid ounces of milk with a milk fat content within the range of from 3 wt. percentage to 5 wt. percentage are added to the base concentrate with mixing without the addition of air. The resulting base concentrate and milk fat solution is then frozen in a freezing chamber maintained at a temperature of −3° F. for a period of at least three hours to prepare the soft frozen fruit flavored dairy product of the instant invention.

1. A soft frozen fruit flavored dairy milk product of a first freezing step and a second freezing step comprising a frozen mix without introduction of air of a first freezing step at a temperature of less than −3° F. to cause ice crystals to form of a first base concentrate of water, a sucrose sugar sweetener, two fruit juices wherein fluid volume ratio of water to fluid volume ratio of a first fruit juice is about 16:32, fluid volume ratio of water to fluid volume ratio of a second fruit juice is greater than the ratio of water to the first fruit juice, weight of sucrose sugar sweetener is equal in weight avoirdupois to liquid volume of water in weight avoirdupois, Brix of water, sucrose sugar solution and two fruit juices is in the range of from 61.0° to 75.0°, sucrose sugar sweetener to fruit weight is from 0.65:1 to 0.74:1, particle hydration of water, sucrose sugar solution, and two fruit juices is 70.0% to 80.0%, warming said frozen mix to melt said mix to slush consistency and second base frozen mix without introduction of air of second freezing step at a temperature less than −3° F. and aging of the said mix of said first base concentrate partially thawed with added dairy milk of 3 to 5 weight percent dairy milk fat, wherein liquid volume of said dairy milk is one-half liquid volume of base concentrate water, wherein Brix of frozen aged second base concentrate with added dairy milk is 61.0% to 75.0%, particle hydration is 70.0% to 80.0%, viscosity is about 1800 c.p.s., coalesced fat particles present of said dairy milk enhance sucrose sugar sweetener, said first base concentrate and said second base concentrate with added dairy milk being free of added emulsifiers, stabilizers, artificial coloring, and without introduction of air into the mixes and into soft frozen fruit flavored dairy milk product.

2. The dairy milk product of claim 1 wherein said fruit juices are selected from the group consisting of pineapple juice, apple juice, orange juice, lemon juice and mixtures thereof.

3. The dairy milk product of claim 1 wherein the first fruit juice is selected from the group consisting of pineapple juice, apple juice and orange juice and the second fruit juice is juice of a citrus fruit.

4. The dairy milk product of claim 1 wherein ratio of fluid volume of water to fluid volume of a second fruit juice is 16:3.
